(19) United States
(12) Patent Application Publication
(10) Pub. No.: US 2025/0319931 A1
(43) Pub. Date: Oct. 16, 2025

(54) PROTECTION APPARATUS FOR A MOTOR VEHICLE WITH IMPROVED RESISTANCE AGAINST PENETRATION OF DEBRIS

(71) Applicant: SOUCY INTERNATIONAL INC., Drummondville (CA)

(72) Inventors: Maxime NORMAND, Victoriaville (CA); Jean-Michel LECLERC, Drummondville (CA); Senad KOPIC, Victoriaville (CA); Alexandre GAUTHIER, Drummondville (CA); Normand ROY, Saint-Hugues (CA); Stephane GAUTHIER, Drummondville (CA)

(21) Appl. No.: 19/175,445

(22) Filed: Apr. 10, 2025

Related U.S. Application Data
(60) Provisional application No. 63/632,927, filed on Apr. 11, 2024.

(51) Int. Cl. B62D 25/20; B62D 21/15

(52) U.S. Cl. CPC B62D 25/2072; B62D 21/15

(57) ABSTRACT

A protective structure for protecting a motor vehicle against impacts and penetration of debris is provided. The protective structure includes a protective plate and a protective cover at least indirectly connected to the protective plate and covers a portion of the floor and/or a portion of the wheel wells of the vehicle to ensure safety of occupants from injuries in case of collision with a debris. The protective plate is a structural member and the protective cover is a sacrificial member, where the protective cover is not fully constrained relative to the protective plate so that a movement of the protective cover relative to the protective plate is possible during such collision. The protective cover can move transversely the protective plate. The protective plate and the protective cover can be separated from each other by a gap that allows the protective cover to deform before abutting the protective plate.

### CROSS-REFERENCE TO RELATED APPLICATIONS

This application claims the benefit of and priority to U.S. provisional patent application No. 63/632,927, filed on Apr. 11, 2024; the content of which is herein incorporated in entirety by reference.

### FIELD OF TECHNOLOGY

The present technology generally relates to protective apparatus to improve resistance to penetration of debris and resistance to impact for use in a motor vehicle such as off-highway vehicles.

### BACKGROUND

Off-highway vehicles are specifically designed to operate in a wide variety of riding environments and situations, whether for sport or utility purposes. Unlike most automobiles, off-highway vehicles can be driven on harsh off-highway terrain. These riding conditions can present safety risks in some cases. For instance, the off-highway vehicles can “bottom out” on an uneven surface. It is common to secure a skid plate under the vehicles to protect the body and lower components of the vehicles from rocks, branches and other debris which may be present on a roadway. Recent safety measures have been directed by the ANSI/ROHVA 1-2023 to reduce risks of injury of occupant(s) of a vehicle from the penetration of a debris. While this update of safety requirements aims to ameliorate safety of occupant(s) of off-highway vehicles, which is a good thing, by increasing the impact absorption property of skid plates, the implementation thereof may increase weight and manufacturing costs of these, as well as the level of difficulty to handle these, in some cases.

### SUMMARY OF TECHNOLOGY

It is an object of the present technology to ameliorate at least some of the drawbacks that exist in the conventional arts.

This section provides a general summary of the disclosure, and is not a comprehensive disclosure of its full scope or all of its features.

In some aspects, the technology described herein relates to a protective apparatus that protects a motor vehicle from penetration of debris.

In some aspects, the technology described herein relates to a protection structure for a motor vehicle, the vehicle having a cab area configured for receiving a seat for an occupant, a floor defining an underside of the vehicle and at least two wheel wells, the protection structure including: a protective plate having an inner surface secured to the underside of the vehicle and an outer surface opposite the inner surface; a protective cover having an inner surface connected to the outer surface of the protective plate and an outer surface facing the ground; and a fastening means configured to connect the protective cover to the protective plate so that the protective cover can move relative to the protective plate when the protection structure encounters a debris.

In some aspects, the technology described herein relates to a protection structure, wherein the protection structure covers at least a portion of the floor extending from the seat to the wheel wells.

In some aspects, the technology described herein relates to a protection structure, wherein the protection structure further covers at least a portion of each of the wheel wells.

In some aspects, technology described herein relates to a protection structure, wherein the protective plate is a structural member and the protective cover is a sacrificial member.

In some aspects, the technology described herein relates to a protection structure, wherein the protective plate is made of a metallic material and the protective cover is made of a low-friction polymeric material.

In some aspects, the technology described herein relates to a protection structure, wherein the protection structure is made of a plurality of sections.

In some aspects, technology described herein relates to a protection structure, wherein the protective plate is made of a plurality of sections.

In some aspects, the technology described herein relates to a protection structure, wherein the protective cover is made of a plurality of sections.

In some aspects, the technology described herein relates to a protection structure, wherein the plurality of sections of the protection structure is connected by a removable anchoring joint.

In some aspects, the technology described herein relates to a protection structure, wherein the plurality of sections of the protective plate is connected by a removable anchoring joint.

In some aspects, the technology described herein relates to a protection structure, wherein the plurality of sections of the protective cover is connected by a removable anchoring joint.

In some aspects, the technology described herein relates to a protection structure, wherein the protective cover can move in a direction transversal to the inner surface of the protective cover.

In some aspects, the technology described herein relates to a protection structure, wherein the protective cover is separated from the protection plate by a gap.

In some aspects, the technology described herein relates to a protection structure, wherein the protective cover can move in a direction normal to the inner surface of the protective cover.

In some aspects, the technology described herein relates to a protection structure, wherein the gap is between 0,005 inch and 0.5 inch or is greater than 0.5 inch.

In some aspects, the technology described herein relates to a protection structure, wherein the fastening means includes a resilient element biasing the protective cover away from the protective plate.

In some aspects, the technology described herein relates to a protection structure, wherein the fastening means includes a spacer.

In some aspects, the technology described herein relates to a protection structure, wherein the fastening means includes an oversized hole in at least one of the protective plate and the protective cover.

In some aspects, the technology described herein relates to a protection structure, wherein the fastening means includes a frangible fastener.

In some aspects, the technology described herein relates to a protection structure, wherein the fastening means includes an embossed portion in at least one of the outer surface of the protective plate and the inner surface of the protective cover.

In some aspects, the technology described herein relates to a protection structure, wherein the fastening means includes a set of magnets including a first magnet in the protective plate and a second magnet in the protective cover, the first and second magnets being arranged in an opposite polarity and creating a repulsive force biasing the protective cover away from the protective plate.

In some aspects, the technology described herein relates to a protection structure, wherein the removable anchoring joint includes a first joint portion on the protective plate and a second joint portion on the protective cover complementary to the first joint portion.

In some aspects, the technology described herein relates to a protection structure, wherein the protection structure meets the safety requirements of ANSI/ROHVA 1-2023 with respect to penetration of debris.

In some aspects, the technology described herein relates to a protection structure, wherein the protection structure provides a resistance to a drop test of an impactor made of a hard material, weighting about 80 lbs, having a conical shape about 2.0 inches of diameter reducing to a tip of about 1.0 inch of diameter over a transition length of about 1.0 inch, and with an approximate impact speed of 10 mph.

In some aspects, the technology described herein relates to a protection structure, wherein the protection structure provides a resistance to an impact energy of 355 joules.

In some aspects, the technology described herein relates to a protection structure, wherein the protection structure is a plurality of protection structure including a first protection structure covering at least a portion of the floor of the vehicle forward the seat and a second protection structure covering at least a portion of the floor of the vehicle rearward the seat.

In some aspects, the technology described herein relates to a protection structure, wherein the vehicle is an off-highway vehicle.

In some aspects, the technology described herein relates to a protection structure, wherein the protection structure reduces risk of having the debris penetrate through the underside of the vehicle and entering the cab area.

In some aspects, the technology described herein relates to a motor vehicle having a floor defining an underside and including the protection structure as defined by any one.

In some aspects, the technology described herein relates to a motor vehicle, wherein the motor vehicle is an off-highway vehicle.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Further areas of applicability will become apparent from the description provided herein. The description and specific examples in this summary are intended for purposes of illustration only and are not intended to limit the scope of the present disclosure.

Additional and/or alternative features, aspects, and advantages of implementations of the present technology will become apparent from the following description, the accompanying drawings, and the appended claims.

### BRIEF DESCRIPTION OF THE FIGURES

For a better understanding of the present technology, as well as other aspects and further features thereof, reference is made to the following description which is to be used in conjunction with the accompanying drawings, where:

FIG. 1 illustrates a perspective view of an off-highway vehicle, in accordance with one embodiment of the present technology;

FIG. 2 illustrates a perspective view of a scenario in which the off-highway vehicle of FIG. 1 enters into contact with a debris;

FIGS. 3A and 3B illustrate a perspective exploded view of parts the off-highway vehicle of FIG. 1, in accordance with one embodiment of the present technology;

FIG. 4 illustrates a perspective exploded view of parts the off-highway vehicle of FIG. 1, in accordance with one embodiment of the present technology;

FIG. 5 illustrates a side exploded view of an off-highway vehicle, in accordance with one embodiment of the present technology;

FIGS. 6A and 6B illustrate parameters of an impact test defined by ANSI/ROHVA standards;

FIG. 7A illustrates a close-up partial view of a conventional skid plate assembly colliding a debris;

FIGS. 7B and 7C illustrate a close-up partial cross-sectional view of a skid plate assembly colliding a debris and deformed by the collision, in accordance with one embodiment of the present technology;

FIG. 8A illustrates a close-up partial cross-sectional view of a skid plate assembly, in accordance with another embodiment of the present technology;

FIG. 8B illustrates a close-up partial cross-sectional view of a skid plate assembly, in accordance with another embodiment of the present technology;

FIG. 9A illustrates a close-up partial cross-sectional view of a skid plate assembly including a resilient element, in accordance with another embodiment of the present technology;

FIG. 9B illustrates a close-up partial cross-sectional view of a skid plate assembly including a resilient element, in accordance with another embodiment of the present technology;

FIG. 10A illustrates a close-up partial cross-sectional view of a skid plate assembly including a spacer, in accordance with another embodiment of the present technology;

FIG. 10B illustrates a close-up partial cross-sectional view of a skid plate assembly including a spacer, in accordance with another embodiment of the present technology;

FIG. 11A illustrates a close-up partial cross-sectional view of a skid plate assembly including an oversized hole in a skid plate cover, in accordance with another embodiment of the present technology;

FIG. 11B illustrates a close-up partial cross-sectional view of a skid plate assembly including an oversized hole in a skid plate, in accordance with another embodiment of the present technology;

FIG. 11C illustrates a close-up partial cross-sectional view of a skid plate assembly including an oversized hole in a skid plate cover, in accordance with another embodiment of the present technology;

FIG. 11D illustrates a close-up partial cross-sectional view of a skid plate assembly including an oversized hole in a skid plate cover and an oversized hole in a skid plate, in accordance with another embodiment of the present technology;

FIG. 12A illustrates a close-up partial cross-sectional view of a skid plate assembly including a hollow frangible fastener, in accordance with another embodiment of the present technology;

FIG. 12B illustrates a close-up partial cross-sectional view of a skid plate assembly including a frangible fastener made of plastic, in accordance with another embodiment of the present technology;

FIG. 12C illustrates a close-up partial cross-sectional view of a skid plate assembly including a frangible fastener having a reduced cross-section, in accordance with another embodiment of the present technology;

FIG. 12D illustrates a close-up partial cross-sectional view of a skid plate assembly including a frangible fastener having a reduced cross-section, in accordance with another embodiment of the present technology;

FIG. 12E illustrates the skid plate assembly of FIG. 12D, in which the frangible fastener is broken;

FIG. 13A illustrates a close-up partial cross-sectional view of a skid plate assembly including an embossed portion on a skid plate, in accordance with another embodiment of the present technology;

FIG. 13B illustrates a close-up partial cross-sectional view of a skid plate assembly including an embossed portion on a skid plate cover, in accordance with another embodiment of the present technology;

FIG. 13C illustrates a close-up partial cross-sectional view of a skid plate assembly including an embossed portion on a skid plate and an embossed portion on a skid plate cover, in accordance with another embodiment of the present technology;

FIG. 14 illustrates a close-up partial cross-sectional view of a skid plate assembly including a set of magnets, in accordance with another embodiment of the present technology;

FIG. 15A illustrates a close-up partial view of a portion of the skid plate assembly of FIG. 3B, identified by “X” annotation in FIG. 3, including an anchoring portion, in accordance with another embodiment of the present technology;

FIG. 15B illustrates a perspective view of the skid plate assembly of FIG. 15A;

FIG. 15C illustrates a modified close-up partial view of a portion of the skid plate assembly of FIG. 3B, identified by “X” annotation in FIG. 3, including an anchoring portion, in accordance with another embodiment of the present technology; and

FIG. 15D illustrates a perspective view of the skid plate assembly of FIG. 15B.

### DETAILED DESCRIPTION

Reference will now be made in detail to embodiments of the present technology, one or more examples of which are illustrated in the drawings. Each example is provided by way of explanation of the present technology, and not meant as a limitation thereof. For example, features illustrated or described as part of one embodiment can be used with another embodiment to yield still a third embodiment.

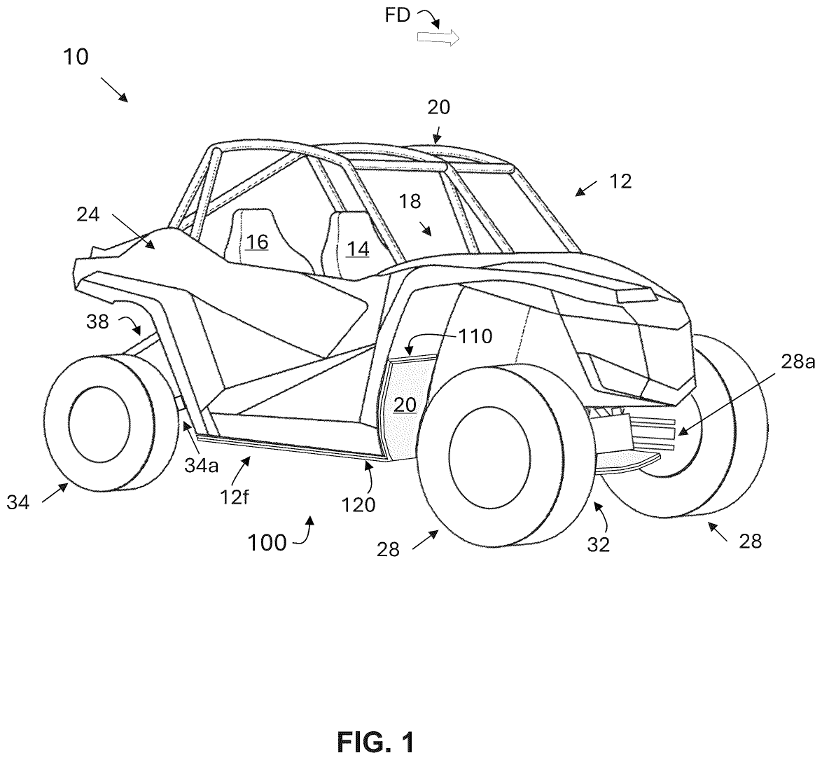

FIG. 1 illustrates a representative off-highway vehicle 10, in accordance with the embodiments of the present technology. In the illustrated embodiment, the off-highway vehicle 10 is a side-by-side vehicle (SSV). It is contemplated that in other embodiments, the off-highway vehicle 10 could be a utility-task vehicle (UTV), an all-terrain vehicle (ATV) or another type of vehicle.

The off-highway vehicle 10 includes a chassis 12, a driver seat 14, a passenger seat 16 in some cases, a steering system 18 forward the driver seat 14. The chassis 12 supports the vehicle components including the seats 14, 16. It is understood that in some embodiments, the vehicle 10 is a single-seater having one seat.

The chassis 12 also supports a roll cage 20 and body panels 24. The chassis is typically constructed with metal tubing. The roll cage 20 is able to provide general impact protection in strategic locations, especially in cases where the vehicle accidentally rolls over, so that injuries to the occupant(s) are prevented or reduced.

The vehicle 10 also includes a powertrain supported by the chassis 12 and configured to generate power and transmit said power to the front and/or the rear ground-engaging elements 28, 34, respectively, i.e., the ground-engaging elements being wheels herein. It is contemplated that the ground-engaging elements could be track systems in some cases. The front wheels 28 are connected to the chassis 12 with a front suspension 32 and the rear wheels 34 are connected to the chassis 12 with a rear suspension 38.

The suspension systems 32, 38, which is connected between the chassis 12 and the wheels 28, 34 allows relative motion between the chassis 12 and the wheels 28, 34 and can enhance handling of the off-highway vehicle 10 by absorbing shocks and helping to maintain adequate traction between the wheels 28, 34 and the ground.

In addition, the front wheels 28 are operatively connected to a front axle 28a and, the rear wheels 34 are operatively connected to a rear axle 34a, where the front axle 28a and/or the rear axles 34a are driven by the powertrain. It is contemplated that in some embodiments, the powertrain could be configured to provide its motive power to only the front axle 28a or to only the rear axle 34a (i.e., in some embodiments, only one of the front axles 28a and/or rear axle 34a could be a driving axle).

The steering system 18 is configured to enable an operator (driver) of the off-highway vehicle 10 to steer the off-highway vehicle 10. To this end, the steering system 18 includes a steering wheel 18a that is operable by the operator to direct the off-highway vehicle 10 along a desired course. In other embodiments, the steering wheel 18a could be replaced by another steering device such as, for instance, a handlebar. The steering system 18 is configured so that in response to the operator handling the steering wheel 18a, the orientation of the front wheels 28 is changed relative to the frame 12, thereby causing the off-highway vehicle 10 to turn in a desired direction.

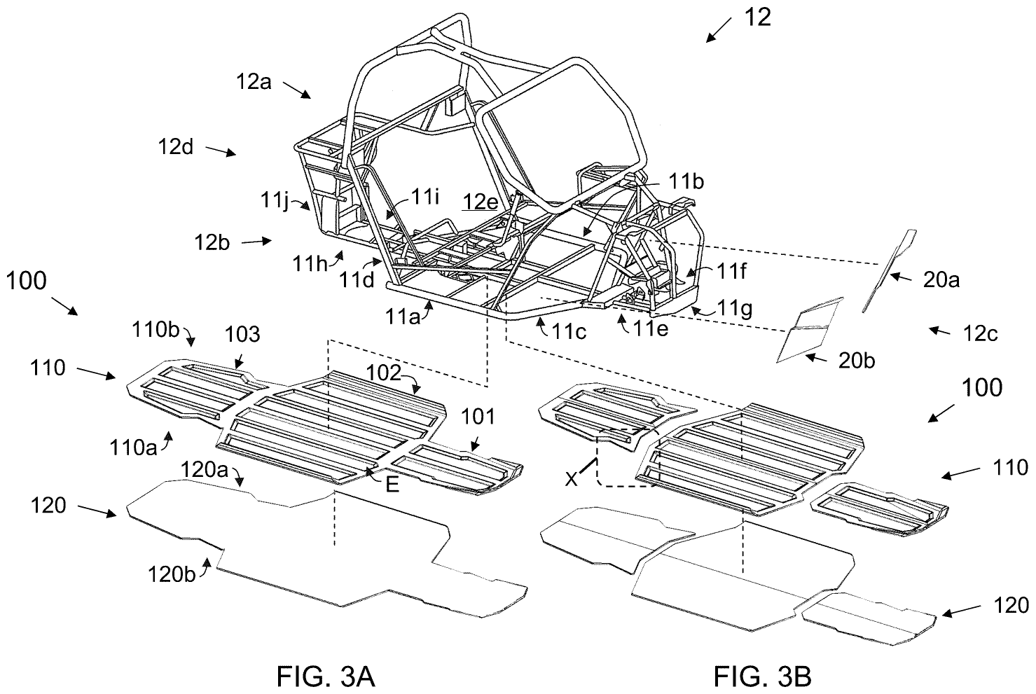

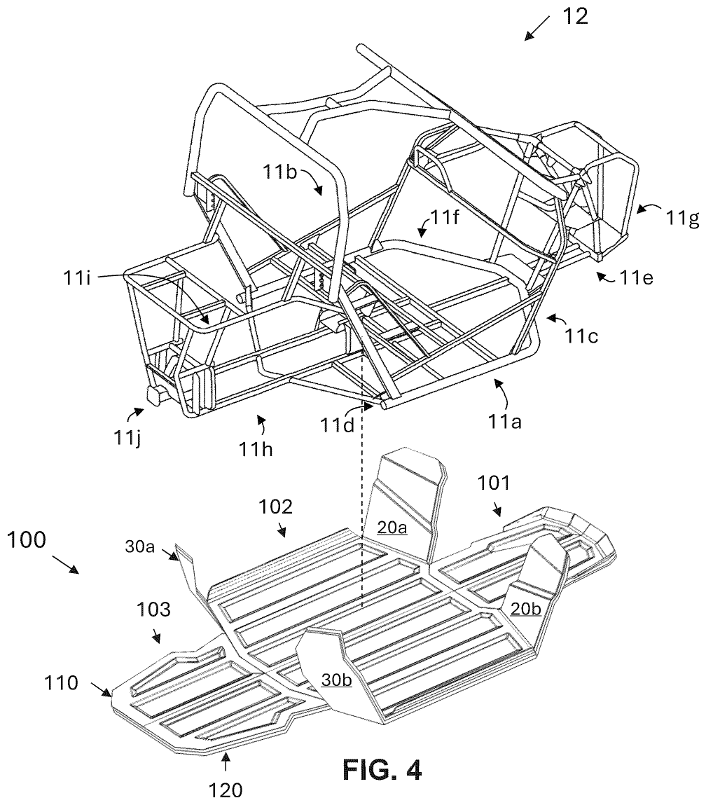

FIGS. 3 and 4 illustrate a representative chassis 12 of the vehicle 10, in accordance with the embodiments of the present technology. It is understood that the design and configuration of the chassis 12 can vary for a given model, type, brand and/or application of the vehicle.

The chassis 12 generally has an upper portion 12a, a lower portion 12b, a front portion 12c and a rear portion 12d. The chassis 12 defines a cab area 12e configured with seats 14, 16 for occupants, and including a floor wall 12f and at least one fender wall 12g. The floor wall 12f and the at least one fender wall 12g are generally part of the lower portion 12b of the chassis 12.

The construction and materials of the floor wall 12f and of the at least one fender wall 12g may vary based on the known techniques in the art.

The floor wall 12f defines an inner floor surface facing the cab area 12e and an outer floor surface facing the ground surface.

The fender wall defines an inner fender surface facing the cab area 12e and an outer fender surface facing one of the front wheels 28 and the rear wheels 34.

### Skid Plate Assembly

Referring back to FIG. 1, an embodiment of a skid plate assembly, referred as a skid plate assembly 100 is described. The skid plate assembly 100 is at least indirectly supported by the bottom surface of the chassis 12 and includes a skid plate 110 and a skid plate cover 120.

Generally speaking, the skid plate assembly 100 is configured to provide a protection barrier against impact and penetration of penetration of debris and thus prevent damages to the vehicle and/or injuries to the occupant(s) thereof.

The skid plate 110 is generally configured to provide mechanical properties favorable for impact resistance and is disposed next to the chassis 12 of the vehicle 10. The skid plate cover 120 is generally configured to provide mechanical properties favorable for abrasion resistance and is disposed next to the skid plate 110 and is exposed to ground.

As described in greater details below, besides providing protection against impact and penetration of debris, the skid plate assembly 100 is configured to be replaceable, inexpensive and recycling-friendly, while being light and aiming to meet the safety requirements of ANSI/ROHVA 1-2023 standard, entitled “American National Standard for Recreational Off-Highway Vehicles”, approved on Mar. 17, 2023 by the American National Standard Institute, Inc., the disclosure of which is incorporated herein by reference in its entirety, referring to ISO 5353 standard, entitled “Earth-moving machinery, and tractors and machinery for agriculture and forestry—Seat index point”, published on Dec. 1, 1995, the disclosure of which is incorporated herein by reference in its entirety.

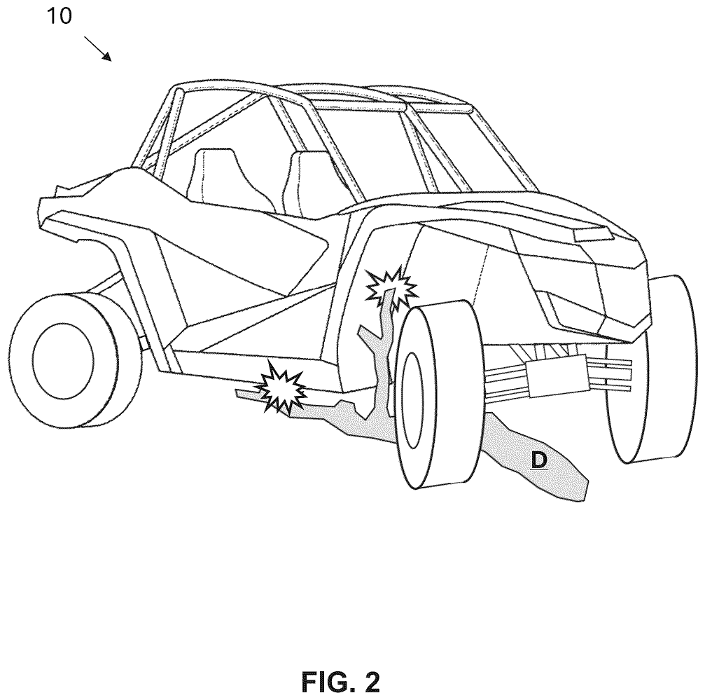

Turning now to FIG. 2, wherein the vehicle 10 overcomes an obstacle (referenced as debris “D”) (e.g., a branch) having protrusions extending in an upward direction that enters in contact with the vehicle 10. In this example, the debris “D” hits the vehicle 10 in a fender area and in a floor area, which can be areas or zones that may be penetrated by the debris “D” and therefore potentially injure the occupant(s) of the vehicle 10 and/or damage the vehicle 10. It is understood that having a reinforcement (i.e., a skid plate assembly) in these zones may prevent occurrence of this unfortunate scenario, or at least reduce its severity. Safety standards, e.g., ANSI/ROHVA, tend to raise the requirements to increase public safety and reduce risks of injuries to occupant(s) and damages to the vehicles.

Referring now to FIGS. 1, 3-5, a description of the skid plate assembly 100 will be provided.

### Floor Protection

Generally speaking, the skid plate assembly 100 is sized, shaped and adapted to generally conform to the bottom surface 12f of the chassis 12 and/or other components of the vehicle 10 (e.g., body panels, liners, axles, engine, powertrain, etc.).

The skid plate assembly 100 is configured to cover at least a portion of the outer floor surface and defines at least one of a front floor-protective portion 101, a central floor-protective portion 102 and a rear floor-protective portion 103.

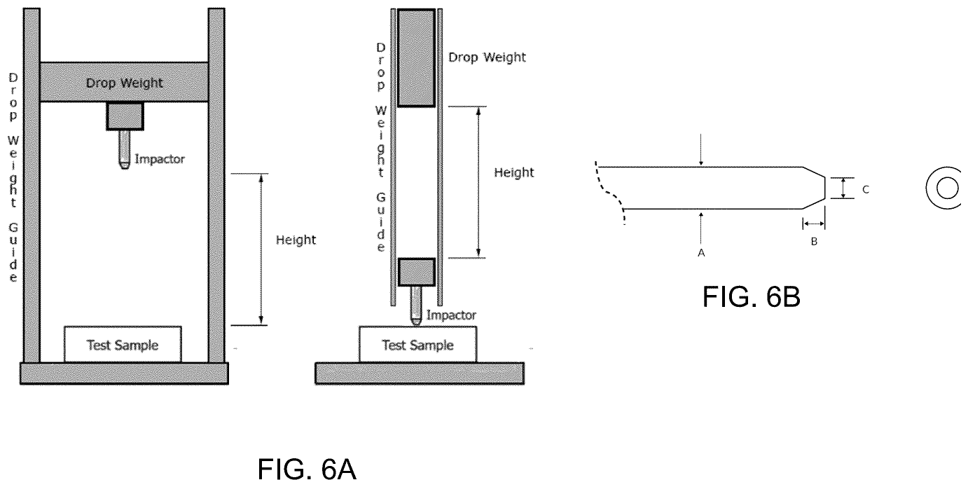

The central floor-protective portion 102 generally extends laterally from a first lateral side 11a (e.g., right door) of the vehicle 10 to a second lateral side 11b (e.g., left door) of the vehicle 10 and generally extends longitudinally from a first longitudinal side 11c (e.g., fender wall) of the vehicle 10 to a second longitudinal side 11d(e.g., wall surface behind the seat(s)) of the vehicle 10. In other words, the central floor-protective portion 102 generally covers the bottom of the cab area 12e and generally protects the vehicle 10 and/or occupant(s) of the vehicle 10 against damages from impacts or penetration of debris coming from the underside of the vehicle 10. As best seen on FIG. 5, the central floor-protective portion 102 generally extends longitudinally minimally from the first longitudinal side 11c (e.g., fender wall) of the vehicle 10 to a transversal plane S extending through the Seat Index Point (SIP), as will be described in further detail below.

The front floor-protective portion 101 generally extends laterally from a third lateral side 11e (e.g., right nose side) of the vehicle 10 to a fourth lateral side 11f (e.g., left nose side) of the vehicle 10 and generally extends longitudinally from the first longitudinal side 11c of the vehicle 10 to a third longitudinal side 11g (e.g., nose front side) of the vehicle 10. In other words, the front floor-protective portion 101 generally covers the bottom of a front area defined between front wheels 28 and generally protects the vehicle 10 and/or occupant(s) of the vehicle 10 against damages from impacts or penetration of debris coming from the underside of the vehicle 10.

Similarly, the rear floor-protective portion 103 generally extends laterally from a fifth lateral side 11h (e.g., right cargo side) of the vehicle 10 to a sixth lateral side 11i (e.g., left cargo side) of the vehicle 10 and generally extends longitudinally from the second longitudinal side of the vehicle 10 to a fourth longitudinal side 11j (e.g., rear cargo side) of the vehicle 10. In other words, the rear floor-protective portion 103 generally covers the bottom of a rear area defined between rear wheels 32 and generally protects the vehicle 10 and/or occupant(s) of the vehicle 10 against damages from impacts or penetration of debris coming from the underside of the vehicle 10.

In some embodiments, at least a given one of the at least one of a front floor-protective portion, a central floor-protective portion and a rear floor-protective portion is integral or at least indirectly connected to another one of the at least one of a front floor-protective portion, a central floor-protective portion and a rear floor-protective portion. FIG. 3A illustrates an embodiment wherein the skid plate 110 is an integral piece of material and the skid plate cover 120 is also an integral piece of material. In other words, in this embodiment, the respective front floor-protective, central floor-protective and rear floor-protective portions of the skid plate 110 and of the skid plate cover 120 are integral.

In some cases, the front, central, and rear floor-protective portions may be installed or replaced independently from each other. FIG. 3B illustrates an embodiment wherein the skid plate 110 is composed of multiple pieces of material and the skid plate cover 120 is also composed of multiple pieces of material. In other words, in this embodiment, the respective front floor-protective, central floor-protective and rear floor-protective portions of the skid plate 110 and of the skid plate cover 120 are independent or at least indirectly connected to each other.

In addition, the skid plate 110 may be indirectly connected to the frame 12 of the vehicle 10. For instance, and without being limited to, the skid plate 110 may be mounted to the frame 12 using brackets, dampers, grommets, spacers, fasteners, or any other means known in the art.

As will be described in further detail below, the skid plate cover 120 may be indirectly connected to the skid plate 110.

It is understood that in some embodiments, different combinations of integral and independent front, central, and rear portions of either the skid plate 110 or the skid plate cover 120, or both, are contemplated for the present technology.

### Fender Protection

In some embodiments, the skid plate assembly 100 is configured to cover at least a portion of the outer fender surface and defines at least one of a front fender-protective portion 20 and a rear fender-protective portion 30.

The front fender-protective portion 20 generally extends laterally and longitudinally to generally cover and conform to at least a portion of the front fender liner or front wheel well of the vehicle 10. In other words, the front fender-protective portion 20 generally covers a portion of the fender liner or front wheel well of the front wheel 28 that is adjacent to the cab area 12e and generally protects the vehicle 10 and/or occupant(s) of the vehicle 10 against damages from impacts or penetration of debris coming from the front wheel well of the vehicle 10. FIG. 2 illustrates such scenario, as mentioned above.

In some cases, the front fender-protective portion 20 is at least indirectly connected to at least a given one of the front floor-protective portion 101 and the central floor-protective portion 102.

In some case, the front fender-protective portion 20 includes a left front fender-protective portion 20a and a right front fender-protective portion 20b.

In some case, the left front fender-protective portion 20a and the right front fender-protective portion 20b are separate from each other. In these cases, it can be said that the left and right front fender-protective portions 20a, 20b may be installed or replaced independently from each other.

Similarly, the rear fender-protective portion 30 generally extends laterally and longitudinally to cover and conform to at least a portion of the rear fender liner or rear wheel well of the vehicle 10. In other words, the rear fender-protective portion 30 generally covers a portion of the fender liner or rear wheel well of the rear wheel 32 that is adjacent to the cab area 12e and generally protects the vehicle 10 and/or occupant(s) of the vehicle 10 against damages from impacts or penetration of debris coming from the rear wheel well of the vehicle 10.

In some case, the rear fender-protective portion 30 includes a left rear fender-protective portion 30a and a right rear fender-protective portion 30b.

In some case, the left rear fender-protective portion 30a and the right rear fender-protective portion 30b are separate from each other. In these cases, it can be said that the left and right rear fender-protective portions 30a, 30b may be installed or replaced independently from each other.

In some cases, the rear fender-protective portion 30 is at least indirectly connected to at least a given one of the central floor-protective portion 102 and the rear floor-protective portion 103.

### Construction

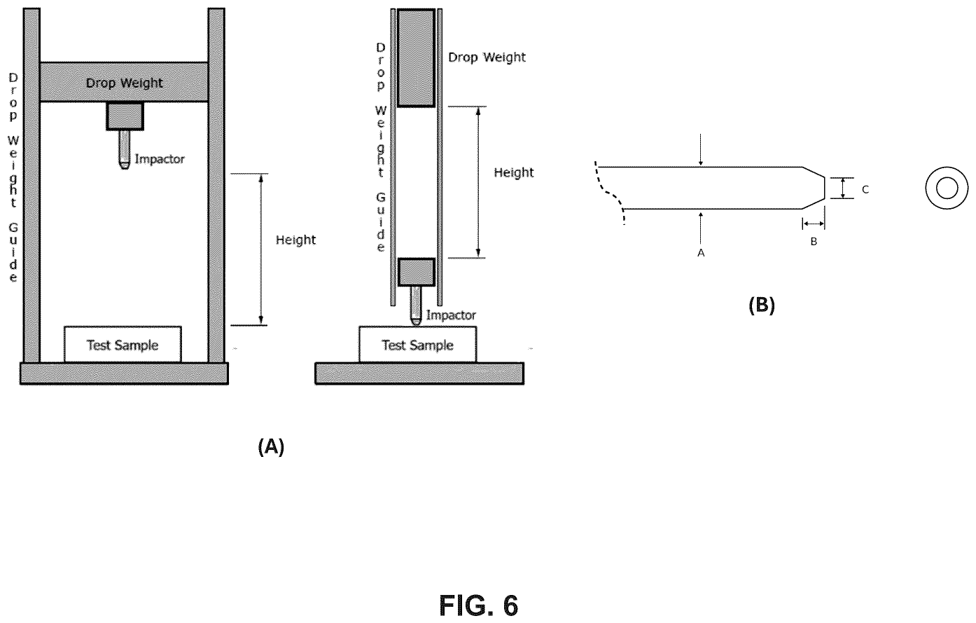

The skid plate assembly 100 includes the skid plate 110 and the skid plate cover 120, forming a composite construction configured for resisting against impacts and penetration of debris. For example and without being limited to, ANSI/ROHVA 1-2023 indicates that the zones identified by “FLOOR” and “FENDER” annotations in FIG. 5—and defined as “forward-facing wheel well” and “area under the vehicle ahead of a vertical plane going through the seat index point (SIP) of the rearmost seat as defined by ISO 5353” in ANSI/ROHVA 1-2023, respectively—should resist to a penetration of debris equivalent to a drop test of an impactor of about 80 lbs having a conical shape about 2.0 inches of diameter (Dimension A) reducing to a tip of about 1.0 inch of diameter (Dimension C) over a transition length of about 1.0 inch (Dimension B), made of a hard material, as shown in FIGS. 6A and 6B. Based on this drop test setup, the protective structure of zones identified by “FLOOR” and “FENDER” annotations should be configured to resist penetration of the full diameter (i.e., Dimension A) of the impactor, which represents an impact energy of approximately 355 joules with an approximate impact speed of 10 mph. The construction of the skid plate assembly 100 aims to meet this requirement while minimizing the weight and cost of the skid plate assembly 100. It is understood that this information is for reference only and one should refer directly to the ANSI/ROHVA standard and/or to any equivalent for more detail and latest information.

Generally speaking, the zones identified by “FENDER” and “FLOOR” annotations are the minimal protection directed by the ANSI/ROHVA standard, i.e., mainly protecting occupant(s) and vehicle against frontal impact and penetration of debris—i.e., impacts that are likely to occur when the vehicle 10 moves in the forward direction (FD). It is contemplated that the skid plate assembly 100 is configured to provide a protection for these minimal zones.

In addition, and referring to FIG. 5, in some embodiments, the skid plate assembly 100 is configured to provide additional protection in zones identified by “FENDER′” and “FLOOR′” annotations to provide an additional protection against rear impacts and penetration of debris—i.e., impacts that are likely to occur when the vehicle 10 moves in the rearward direction (opposite to direction FD). In some cases, the skid plate assembly 100 includes a front skid plate assembly 100a configured to protect at least one of the zones identified by “FENDER” and “FLOOR” annotations and a rear skid plate assembly 100b configured to protect at least one of the zones identified by “FENDER′” and “FLOOR′” annotations.

In some cases, the front and rear skid plate assemblies 100a, 100b have a similar construction. In some other cases, the front and rear skid plate assemblies 100a, 100b have a different construction. For example, the rear skid plate assembly 100b could be made of a construction less resistant than the front skid plate assembly 100a, since the severity of collisions against a debris D occurring while the vehicle moves in the rearward direction is likely to be lower than the severity of those occurring while the vehicle moves in the frontward direction.

In some cases, the front and rear skid plate assemblies 100a, 100b are at least indirectly connected to each other. In some other cases, the front and rear skid plate assemblies 100a, 100b are independent from each other.

### Skid Plate

Generally speaking, the skid plate 110 is a structural member of the skid plate assembly 100, i.e., having mechanical properties that are favorable for protection against penetration of debris, and/or having the ability to absorb shock and/or impact energy without breaking. The skid plate 110 defines an inner surface 110a facing the skid plate cover 120 and an outer surface 110b facing the chassis 12 of the vehicle 10.

Various materials are contemplated for the skid plate 110, for example, but without being limited to, metallic materials (e.g., aluminum, titanium, steel, or the like), impact-resistant polymers (e.g., acrylonitrile butadiene styrene (ABS), polycarbonate (PC), high-density polyethylene (HDPE), polyphenylsulfone (PPSU), ultra-high molecular weight polyethylene (UHMW-PE)), polyamide-imide (PAI), high impact polystyrene (HIPS), or the like), fiber-reinforced polymers (e.g., fiberglass fibers, carbon fibers, aramide fibers, or the like), or any other suitable materials, used alone or as composite materials. In the present embodiment, the preferred material for the skid plate 110 is aluminum, since it has a relatively low density, is corrosion-resistant, and is flexible enough to absorb impact energy without breaking.

### Skid Plate Cover

The skid plate cover 120 is a sacrificial member of the skid plate assembly 100 having mechanical properties (e.g., coefficient of friction, wear resistance, or the like) that are adequate for allowing the vehicle 10 to “slide” on protruding obstacles, and/or having the ability to resist against abrasion and/or friction. The skid plate cover 120 defines an inner surface 120a facing the skid plate 110 and an outer surface facing the ground surface 120b.

Various materials are contemplated for the skid plate cover 120, for example, but without being limited to, polymeric materials (e.g., polyethylene, ultra-high molecular weight polyethylene (UHMW-PE), polyamide (PA, nylon), polyoxymethylene (POM, acetal), polyether ether ketone (PEEK), polyimide (e.g. Vespel™), polydicyclopentadiene (pDCPD), or any other suitable materials, used alone of as a constituent of composite materials. In the present embodiment, the preferred material for the skid plate cover 120 is polyethylene or ultra-high molecular weight polyethylene (UHMW).

### Cooperative Effect of the Skid Plate and Skid Plate Cover

It is understood that, when combined together to form the skid plate assembly 100, the skid plate 110 and the skid plate cover 120 may collaborate or cooperate to provide a global impact resistance that, in some cases, is greater than the sum of specific impact resistance of each of the skid plate 110 and the skid plate cover 120. In some instances, this cooperation between the skid plate 110 and the skid plate cover 120 is a synergistic collaboration to provide a global impact resistance that, in some cases, is greater than the sum of specific impact resistance of each of the skid plate 110 and the skid plate cover 120.

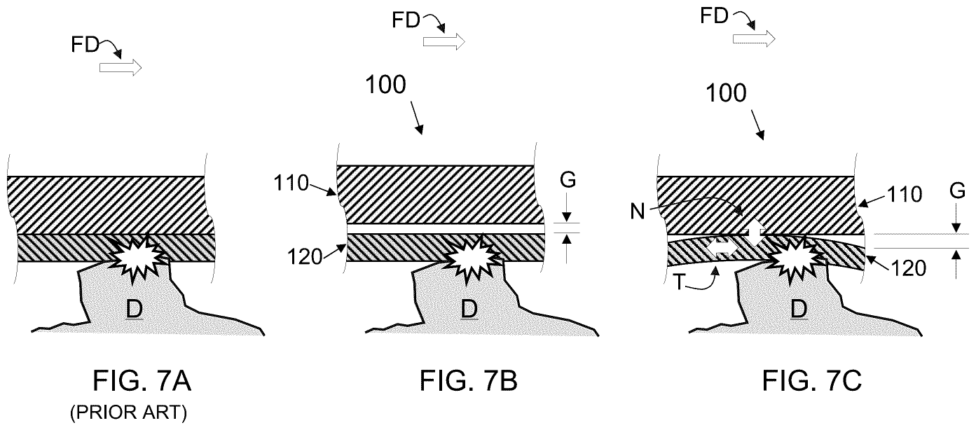

Use of multiple layers of different materials for forming a conventional skid plate is known in the art. Some skid plates comprise a first layer of hard or mechanically resistant material (e.g., metal, composites, or the like) and a second layer of light and weak material adjacent (e.g., foam material, or the like). Other skid plates further comprise a third layer of hard or mechanically resistant material added to form a “sandwich composite” with the layer of light and weak material is between the two layers of hard or mechanically resistant material. Conventionally, the layers are permanently joined together along the majority of their surface (i.e., considered integral) via various techniques (e.g., bonding, adhesive, thermal welding, co-molding, overmolding, etc.). An example of a conventional joined-layers composite is shown in FIG. 7A.

### Boundary Condition Between the Skid Plate and the Skid Plate Cover

In the present technology, the skid plate 110 and the skid plate cover 120 are not fully constrained to each other. By so, the global impact resistance or global energy absorption capacity of the skid plate assembly 100 is enhanced.

In some embodiments, the skid plate 110 and the skid plate cover 120 are distant from each other in a direction normal to their effective surface. In other words, there is a gap G between the skid plate 110 and the skid plate cover 120. In some embodiments, the gap G is constant between the skid plate 110 and the skid plate cover 120. In some embodiments, the gap G varies between the skid plate 110 and the skid plate cover 120, at least in certain regions therebetween. The variation of the gap G between the skid plate 110 and the skid plate cover 120 may be material in the longitudinal direction of the skid plate assembly 100 or in the lateral direction of the skid plate assembly 100.

In some other embodiments, the gap G may be null in certain regions between the skid plate 110 and the skid plate cover 120 while being material in certain other regions between the skid plate 110 and the skid plate cover 120.

It is believed that the gap G between the skid plate 110 and the skid plate cover 120 may help the skid plate assembly 100 to absorb the impact energy in case of a collision with a debris. Generally speaking, the skid plate cover 120 is more elastic than the skid plate 110 and thus may deform of a greater amount in comparison thereto. Without being bound to any specific theory, when the skid plate cover 120 is adjacent and joined/integral to the skid plate 110 (as in conventional composite skid plates) so that the skid plate 110 and the skid plate cover 120 are fully constrained to each other, the contribution of the specific mechanical resistance of the skid plate cover 120 may not be appreciable in comparison with the specific mechanical resistance of the skid plate 110, as depicted in FIG. 7A.

Referring to FIGS. 7B and 7C, it is believed that the contribution of the specific mechanical resistance of the skid plate cover 120 may be more appreciable if the skid plate cover 120 is “free” to deform without being completely restricted by the skid plate 110, at least to a given range of deformation before being restricted by the skid plate 110, where the range of deformation depends on the gap G, among other things. In other words, thanks to the gap G between the skid plate 110 and the skid plate cover 120, the skid plate cover 120 may deform in a direction N (e.g., compression direction normal to or out-of-plane of the outer surface 120b of the skid plate cover 120) so that a portion of the impact energy is absorbed by the skid plate cover 120 before being in contact with the skid plate 110.

In some embodiments, the gap G between the skid plate 110 and the skid plate cover 120 may allow a transversal movement in a direction T (e.g., shear direction parallel to the outer surface 120b of the skid plate cover 120) so that a portion of the impact energy is absorbed by the transversal movement of the skid plate cover 120 relative to the skid plate 110.

In some embodiments, a combination of the out-of-plane deformation and transversal movement of the skid plate cover 120 relative to the skid plate 110 contributes to enhance the global impact resistance or global energy absorption capacity of the skid plate assembly 100.

The determination of the gap G may vary in accordance with several parameters, such as, but not limited to, available or desired distance (clearance) between the skid plate cover 120 and another component of the vehicle 10 or between the outer surface 120b of the skid plate cover 120 and the ground surface, for instance. Other examples may be the desired amount of impact energy to be absorbed by the skid plate assembly 100 or more specifically by the skid plate cover 120, the specific mechanical resistance of the each of the skid plate 110 and the skid plate cover 120, the thickness of the skid plate 110 and/or of the skid plate cover 120, the fixation means between the skid plate 110 and the skid plate cover 120 (if applicable). Different ranges of gap G are contemplated, from 0,005″ to 0,500″. In some cases, the gap G is a play between the skid plate cover 120 and the skid plate 110, while in some other cases, the gap G is a space or a distance therebetween. In some cases, the gap G may be greater than 0,500″.

In some cases, the gap G is negligible (providing immaterial out-of-plane deformation of the skid plate cover 120 relative to the skid plate 110) but still provides a material transversal movement of the skid plate cover 120 relative to the skid plate 110. In other words, in these cases, the gap G is configured to ensure that the skid plate cover 120 and the skid plate 110 are independent without necessarily allowing a material absorption of impact energy in the direction N.

Different configurations are contemplated to indirectly connect the skid plate 110 to the skid plate cover 120 and thus providing a pre-determined gap G therebetween, in whole or in certain regions thereof, as will be described below.

### First Embodiment of Gap Configuration (Loose)

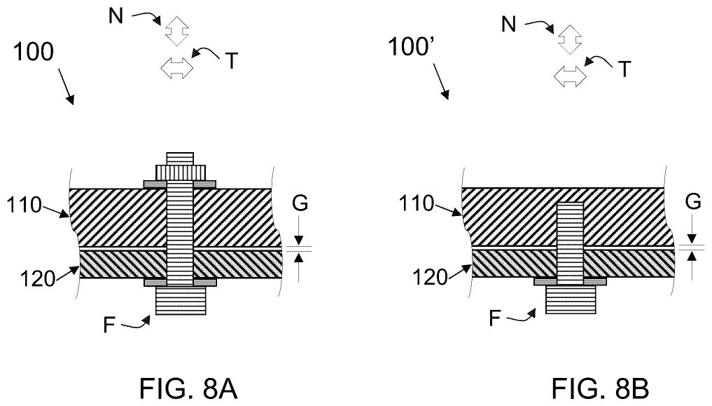

Referring to FIGS. 8A and 8B, a first set of embodiments of gap configuration will be described. In FIG. 8A, the skid plate 110 and the skid plate cover 120 are distant to each other by the gap G. Herein, the fastener assembly F is configured to maintain the relative position of the skid plate cover 120 and the skid plate 110 in at least one of the longitudinal and transversal directions (i.e., movement in direction T being immaterial), while allowing a movement of the skid plate cover 120 relative to the skid plate 110 in the direction N. In other words, the fastener assembly F does not urge or force the skid plate cover 120 to abut the skid plate 110, but rather a loose configuration out-of-plane thereof. FIG. 8B shows a configuration similar to the one shown in FIG. 8A, but using an alternate fastener assembly F, with differs from the fastener assembly F of FIG. 8A. It is understood that the fastener assembly F shown is an example only and that other configurations are contemplated.

### Second Embodiment of Gap Configuration (Resilient Element)

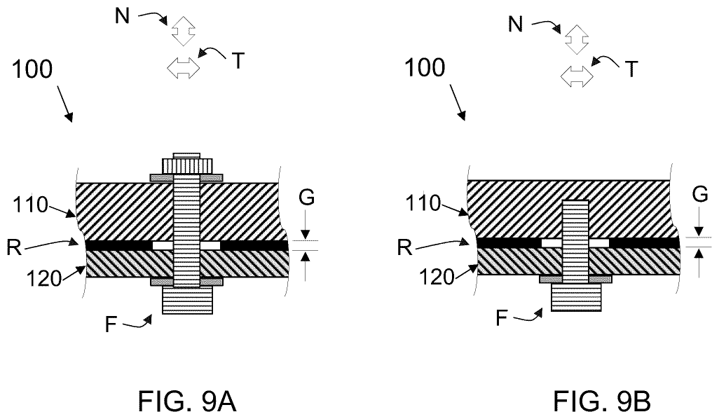

Referring to FIGS. 9A and 9B, a second set of embodiments of gap configuration will be described. This set of embodiments is similar to the first set of embodiments, the main difference being that a resilient element R is present between the skid plate cover 120 and the skid plate 110 to urge the skid plate cover 120 away from the skid plate 110. In some cases, the resilient element may contribute to reducing vibration. The resilient element R may be a gasket, a pad, a spring, or any other suitable flexible or elastic component disposed between the skid plate 110 and the skid plate cover 120. The resilient element R may be made of an elastomeric material (e.g., rubber), of a polymeric material, of a metallic material, or of any combination thereof. It is understood that the fastener assembly F shown is an example only and that other configurations are contemplated.

### Third Embodiment of Gap Configuration (Spacer)

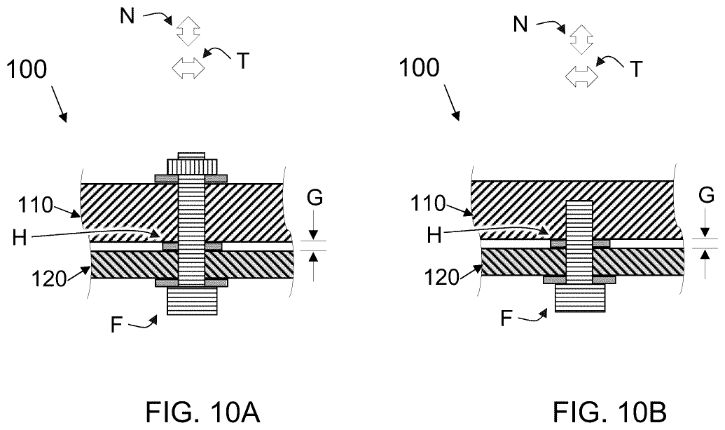

Referring to FIGS. 10A and 10B, a third set of embodiments of gap configuration will be described. This set of embodiments is similar to the second set of embodiments, the main difference being that a spacer H is present between the skid plate cover 120 and the skid plate 110 instead of the resilient element R. The spacer H is configured to maintain the gap G between the skid plate cover 120. The spacer H may be a washer, a shim, a part, or any other suitable rigid component disposed between the skid plate 110 and the skid plate cover 120 having a thickness corresponding to the gap G. The spacer H may be made of a polymeric material or of a metallic material, for instance. It is understood that the fastener assembly F shown is an example only and that other configurations are contemplated.

### Fourth Embodiment of Gap Configuration (Spacer and Oversized Hole)

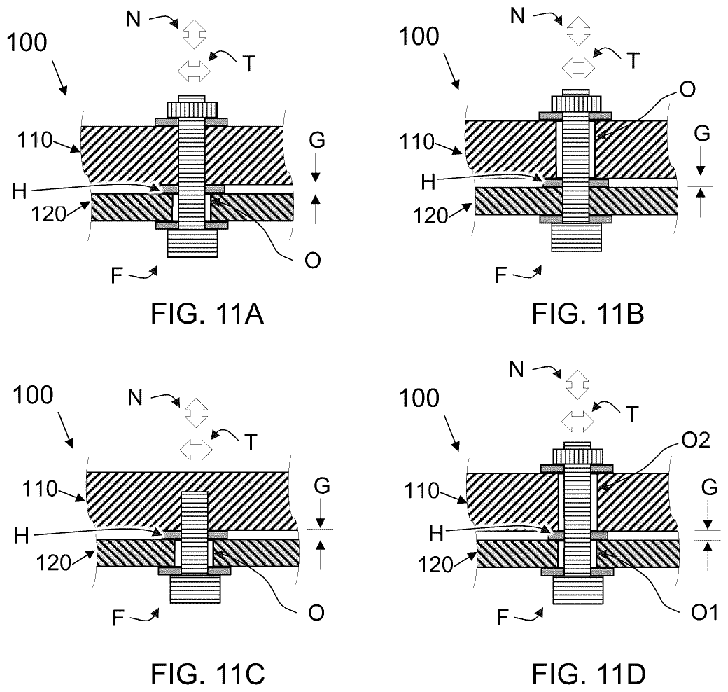

Referring to FIGS. 11A to 11D, a fourth set of embodiments of gap configuration will be described. This set of embodiments is similar to the third set of embodiments, the main difference being that an oversized hole O is added on at least one of the skid plate 110 and the skid plate cover 120 to allow the fastener assembly F (since the size of the oversized hole O is bigger than the size of the fastener assembly F), and thus the skid plate cover 120 to move transversally relative to the skid plate 110. In some cases, the fastener assembly F is cylindrical and defines a diameter. In some cases, the oversized hole O is a circular hole defining a diameter bigger than the diameter of the fastener assembly F which allows a symmetrical radial movement of the skid plate cover 120 relative to the skid plate 110.

In some cases, the oversized hole O is a slot which allows an asymmetrical radial movement of the skid plate cover 120 relative to the skid plate 110. In FIG. 11A, the oversized hole is present in the skid plate cover 120, while in FIG. 11B, the oversized hole O is present in the skid plate 110. FIG. 11C is similar to the configuration shown in FIG. 11A but with an alternate fastener assembly F. In FIG. 11D, a first oversized hole O1 is present in the skid plate cover 120 and a second oversized hole O2 is present in the skid plate 110. In all these cases, the presence of at least one oversized hole O allows the skid plate cover 120 to move in the direction T.

### Fifth Embodiment of Gap Configuration (Frangible Fastener Assembly)

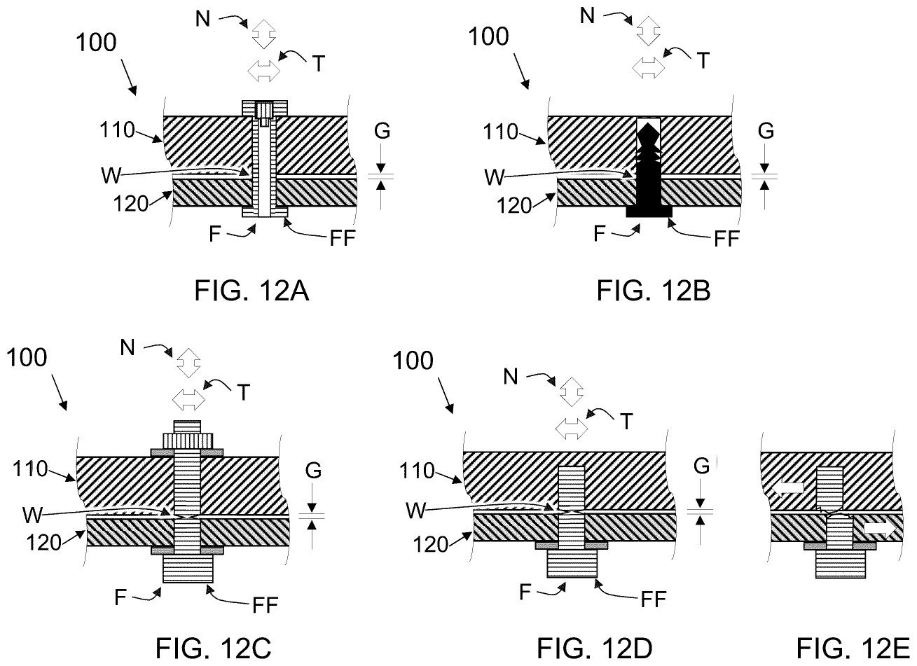

Referring to FIGS. 12A to 12D, a fifth set of embodiments of gap configuration will be described. This set of embodiments is similar to the first set of embodiments, the main difference being that the fastener assembly F includes a frangible fastener FF that is configured to break easily when a shear force greater than a pre-determined value is applied to it. In other words, the frangible fastener FF is readily weaken by a frangible region W where the mechanical resistance to shear is voluntarily lower than the rest of the fastener assembly F so that this frangible region W breaks and allows a separation of a first portion of the fastener assembly F received in the skid plate 110 from a second portion of the fastener assembly F received in the skid plate cover 120. For instance, the frangible fastener FF—or at least the frangible portion W thereof—may be hollow as shown in FIG. 12A, where the frangible fastener FF is a rivet, and/or made of a brittle or fragile material as shown on FIGS. 12A, 12C and 12D or of a plastic material as shown in FIG. 12 B, where the frangible fastener FF is a plastic push-pin. In other cases, the cross-section of the frangible fastener FF is reduced at the frangible portion W, as shown in FIGS. 12C and 12D. In FIG. 12E, the fastener assembly F of FIG. 12D is shown after breakage thereof under shear stress due to an impact with a debris, for instance. It is understood that in all these embodiments, the fastener assembly F is useful to maintain the skid plate assembly 100 altogether, i.e. facilitates the installation/replacement of the skid plate 110 and the skid plate cover 12 on the vehicle 10, while allowing a relative movement between the skid plate 110 and the skid plate cover 120 when an impact greater than the shear resistance of the frangible fastener FF causes breakage thereof and liberate the skid plate cover 120. The skid plate cover 120—or at least a portion thereof—then becomes free to move in at least one of the direction T and the direction N. Without being bound to any specific theory, it is also contemplated that the frangible fastener FF may contribute absorbing a portion of the impact energy by its shear resistance up to its breakage.

### Sixth Embodiment of Gap Configuration (Emboss)

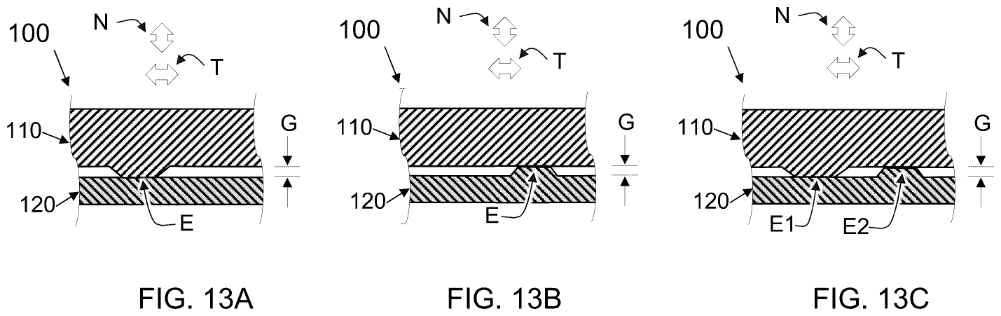

Referring to FIGS. 13A to 13C, a sixth set of embodiments of gap configuration will be described. This set of embodiments is similar to the other set of embodiments, the main difference being that the gap G is provided by embossed portions E extending or protruding from at least one of the inner surface 110a of the skid plate 110 and the inner surface 120a of the skid plate cover 120. In FIG. 13A, the embossed portion E is located on and extends from the inner surface 110a of the skid plate 110 and is in contact with the inner surface 120a of the skid plate cover 120 so that the gap G is formed therebetween. Similarly, in FIG. 13B, the embossed portion E is located and extends from the inner surface 120a of the skid plate cover 120 and is in contact with the inner surface 110a of the skid plate 110. FIG. 13C shows a case where a first embossed portion E1 is located on and extends from the inner surface 110a of the skid plate 110 and is in contact with the inner surface 120a of the skid plate cover 120 and a second embossed portion E2 is located and extends from the inner surface 120a of the skid plate cover 120 and is in contact with the inner surface 110a of the skid plate 110. In some cases, the first and second embossed portions E1, E2 may be aligned to that the gap G is formed by the sum of the first and second embossed portions E1, E2. In some cases, the embossed portions E may be located at specific locations or zones where a greater the global impact resistance is required. In other words, the embossed portions E may be used as reinforcing elements for modularly increasing the global impact resistance of the skid plate assembly 100 at specific locations or portions thereof. In some cases, the embossed portions E may be located proximate the fastener assembly F described in the previous sets of embodiments for instance, or distant therefrom. In other words, the embossed portions E may be combined with the fastener assembly F to provide the gap G or distant from the fastener assembly F to contribute to enhancing the global impact resistance of the skid plate assembly 100.

### Seventh Embodiment of Gap Configuration (Magnets)

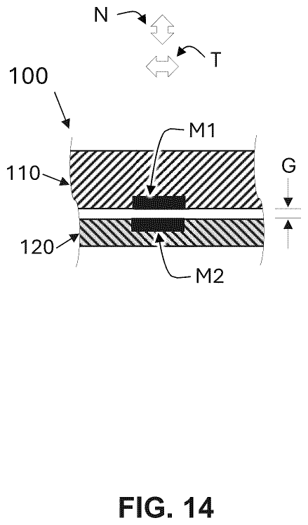

Referring to FIG. 14, a seventh set of embodiments of gap configuration will be described. This set of embodiments is similar to the other set of embodiments, the main difference being that the gap G is provided by sets of magnets comprising a first magnet M1 disposed on the inner surface 110a of the skid plate 110 and a second magnet M2 on the inner surface 120a of the skid plate cover 120 and in opposite polarity so that the first and second magnets M1, M2 create a repulsing force urging the skid plate cover 120 away from the skid plate 110. In some cases, the set of magnets M may be located proximate the fastener assembly F described in the previous sets of embodiments for instance, or distant therefrom. In other words, the set of magnets M may be combined with the fastener assembly F to provide the gap G or distant from the fastener assembly F to contribute to enhancing the global impact resistance of the skid plate assembly 100.

### Connection Configuration Between Adjacent Portions of the Skid Plate Assembly

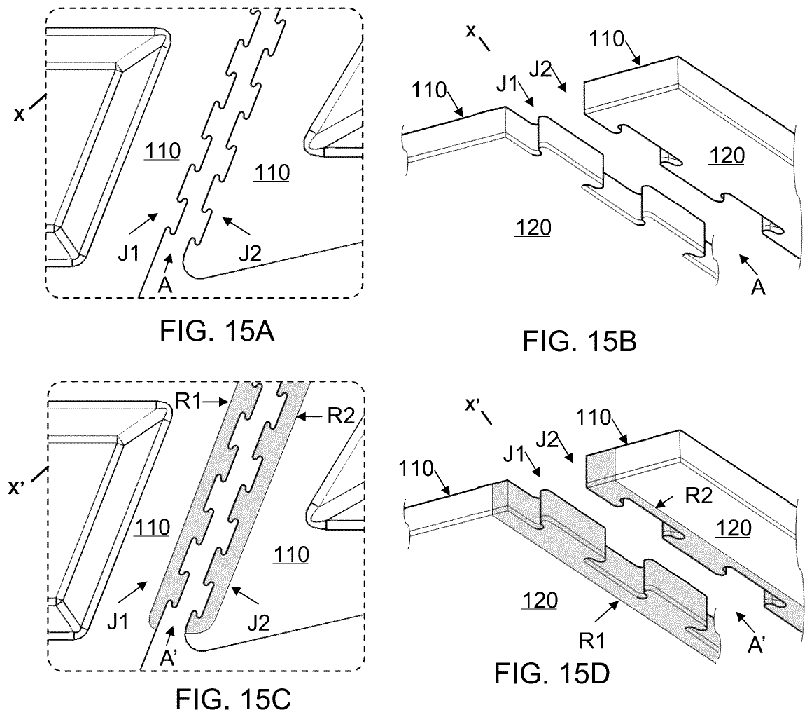

Referring to FIGS. 15A and 15B, an embodiment of connection configuration between adjacent portions of the skid plate assembly 100 is shown. FIG. 15A is a top view of the portion identified by “X” annotation in FIG. 3 and shows an anchoring joint A that is configured to removably connect two adjacent portions of the skid plate assembly 100, such as the front floor-protective portion 101, the central floor-protective portion 102, the rear floor-protective portion 103, the front fender-protective portion 20, and/or the rear fender-protective portion 30. In some cases, the anchoring joint A is configured to provide an interlocking configuration between the first section and the second section of the skid plate assembly 100.

The anchoring joint A includes a first engaging portion J1 on a first section of the skid plate assembly 100 and a second engaging portion J2 on a second section of the skid plate assembly 100. The first and second engaging portions J1, J2 are configured to engage each other by sliding the first and second engaging portions J1, J2 on one another. A given one of the first and second engaging portions J1, J2 includes a plurality of laterally distributed tenons while another one of the first and second engaging portions J1, J2 includes a plurality of laterally distributed mortises. The plurality of laterally distributed mortises and the plurality of laterally distributed tenons form a plurality of laterally distributed mechanical interlocking joints (e.g., dovetail or jigsaw puzzle knob/socket shape, or the like) when the first and second engaging portions J1, J2 are assembled. In some cases, the first and second engaging portions J1, J2 are mirror from each other, but other configurations are contemplated. In some cases, the first and second engaging portions J1, J2 are complementary with a positive tolerance (e.g., slide fit) and/or connectable to each other with force (i.e. negative tolerance between the first and second engaging portions J1, J2, e.g., snug fit).

It is understood that having an anchoring joint A connecting adjacent sections of the skid plate assembly 100 that is selectively removable or disconnectable may facilitate installation/replacement of the skid plate assembly 100 on the vehicle 10, and may contribute to enhancing the global impact resistance of the skid plate assembly 100 in some cases. In fact, since the anchoring joint A is designed to be easily disconnected or disassembled, e.g., when a debris impacts the skid plate assembly 100, the disconnection of adjacent sections of the skid plate assembly 100 may absorb a portion of the impact energy in some cases, before liberating the disconnected adjacent sections of the skid plate assembly 100.

FIGS. 15C and 15D show an alternate embodiment of the anchoring joint A, namely anchoring joint A′. FIG. 15C is a modified top view of the portion identified by “X” annotation in FIG. 3 and shows the anchoring joint A′ that is similar to the anchoring joint A, but includes a first resilient portion R1 on the first section of the skid plate assembly 100 and a second resilient portion R2 on the second section of the skid plate assembly 100. Resilient portions R1, R2 are configured to allow a greater deformation, and thus a greater absorption of impact energy, before disconnection of the anchoring joint A′ when the skid plate assembly 100 is hit by a debris. In some cases, one of the first and second resilient portions R1, R2 may be omitted.

Even if the anchoring joints A, A′ shown in FIGS. 15A to 15D are illustrated as being defined in both skid plate 110 and skid plate cover 120, in some cases, only a given one of the skid plate 110 and the skid plate cover 120 includes an anchoring joint as described. For example, the skid plate 110 may have an anchoring joint and the skid plate cover 120 may be at least indirectly connected to the skid plate 110, as described above. In another example, the skid plate 110 may be integral and sections of the skid plate cover 120 may be connected to each other via an anchoring joint as described. Other configurations are contemplated.

### Operation

In operation, it is believed that the present technology described above contributes to enhancing the global impact resistance and penetration of debris of the skid plate assembly 100.

Generally referring to FIGS. 1, 2, 5, 7B, and 7C, when a debris D hits a section of the skid plate assembly 100, for instance the front-floor protective portion 101, the debris D contacts the skid plate cover 120 first. Since the skid plate cover 120 is not fully constrained relative to the skid plate 110 of the skid plate assembly 100, the skid plate cover 120 may move relative from the skid plate 110, at least in one of the direction N and direction T. The movement of the skid plate cover 120 absorbs a portion of the impact energy before the skid plate 110 is involved in the impact resistance. In other words, the specific impact resistance of the skid plate cover 120, since the skid plate cover 120 is not fully constrained relative to the skid plate 110, provides an independent contribution to the global impact resistance of the skid plate assembly 100 before the contribution of the skid plate 110 in said global impact resistance of the skid plate assembly 100 is involved.

In some cases, the gap G between the skid plate cover 120 and the skid plate 110 allows for deformation of the skid plate cover 120 in the direction N before contacting or abutting the skid plate 110. In some cases, the skid plate cover 120 may move transversely in direction T relative to the skid plate 110. As best seen in FIG. 7C, the movement of the skid plate cover 120 relative to the skid plate 110 (e.g. translation, deformation, etc.) illustrates the advantageous configuration provided by the skid plate assembly 100 wherein the skid plate cover 120 is at least partially decoupled from the skid plate 110, and provides an enhanced global impact energy absorption in case of a collision with a debris. Since the skid plate cover 120 is generally flexible, the skid plate cover 120 may retrieve its original shape in some cases once the skid plate assembly 100 clears the debris.

In some cases, the connection between adjacent sections of the skid plate assembly 100 and/or between the skid plate cover 120 and the skid plate 110 is frangible or easily disconnectable when the skid plate assembly 100 collides a debris, so that the movement of the skid plate cover 120 relative to the skid plate 110 causes at least partial disconnection of a portion of the connection between adjacent sections of the skid plate assembly 100, which may contribute to absorb a portion of the impact energy and thus enhance the global impact resistance of the skid plate assembly 100 and better protect the occupant(s) of the vehicle 10. Replacement of broken frangible fasteners used to connect the skid plate cover 120 to the skid plate 110 and/or the sections of the skid plate assembly 100 may be performed.

In some cases, the connection between sections of the skid plate assembly 100 and the vehicle 10 is removable. Similarly, in some cases, the connection between sections of the skid plate cover 120 and sections of the skid plate 110 is removable. These cases may contribute to facilitate installation/replacement of a given section of the skid plate assembly 100, of the skid plate 110, and/or of the skid plate cover 120 that may be too worn to ensure safety of the occupant(s) of the vehicle 10.

Similarly, because of the removable connection between various sections of the skid plate assembly 100, recycling of worn sections may be facilitated by possible separation of different materials thereof.

Modifications and improvements to the above-described embodiments of the present invention may become apparent to those skilled in the art. The foregoing description is intended to be exemplary rather than limiting.

For example, despite the present technology has been applied to the front portion of the vehicle, it is contemplated that the present technology could also be used to provide protection against penetration of debris for the rear portion of the vehicle (e.g. behind the seats, rear fenders, etc.), for the side portion of the vehicle (e.g. door panels, etc.) or for the upper portion of the vehicle (e.g. top panels, etc.).

What is claimed is:

1. A protection structure for a motor vehicle, the vehicle having a cab area configured for receiving a seat for an occupant, a floor defining an underside of the vehicle and at least two wheel wells, the protection structure comprising:
a protective plate having an inner surface secured to the underside of the vehicle and an outer surface opposite the inner surface;
a protective cover having an inner surface connected to the outer surface of the protective plate and an outer surface facing a ground surface; and
a fastening means configured to connect the protective cover to the protective plate so that the protective cover can move relative to the protective plate when the protection structure encounters a debris.

2. The protection structure of claim 1, wherein the protection structure covers at least a portion of the floor extending from the seat to the wheel wells.

3. The protection structure of claim 1, wherein the protection structure further covers at least a portion of each of the wheel wells.

4. The protection structure of claim 1, wherein the protective plate is a structural member and the protective cover is a sacrificial member.

5. The protection structure of claim 1, wherein the protection structure is made of a plurality of sections.

6. The protection structure of claim 1, wherein the protective plate is made of a plurality of sections.

7. The protection structure of claim 1, wherein the protective cover is made of a plurality of sections.

8. The protection structure of claim 5, wherein the plurality of sections of the protection structure is connected by a removable anchoring joint.

9. The protection structure of claim 6, wherein the plurality of sections of the protective plate is connected by a removable anchoring joint.

10. The protection structure of claim 7, wherein the plurality of sections of the protective cover is connected by a removable anchoring joint.

11. The protection structure of claim 1, wherein the protective cover can move in a direction transversal to the inner surface of the protective cover.

12. The protection structure of claim 1, wherein the protective cover is separated from the protection plate by a gap.

13. The protection structure of claim 1, wherein the protective cover can move in a direction normal to the inner surface of the protective cover.

14. The protection structure of claim 1, wherein the fastening means includes a resilient element biasing the protective cover away from the protective plate.

15. The protection structure of claim 1, wherein the fastening means includes a spacer.

16. The protection structure of claim 1, wherein the fastening means includes an oversized hole in at least one of the protective plate and the protective cover.

17. The protection structure of claim 1, wherein the fastening means includes a frangible fastener.

18. The protection structure of claim 1, wherein the fastening means includes an embossed portion in at least one of the outer surface of the protective plate and the inner surface of the protective cover.

19. The protection structure of claim 1, wherein the fastening means includes a set of magnets including a first magnet in the protective plate and a second magnet in the protective cover, the first and second magnets being arranged in an opposite polarity and creating a repulsive force biasing the protective cover away from the protective plate.

20. A motor vehicle having a floor defining an underside and including the protection structure as defined by claim 1.
